(19) United States
(12) Patent Application Publication
(10) Pub. No.: US 2002/0032044 A1
(43) Pub. Date: Mar. 14, 2002

(54) Radio communication terminal having a lighting control mechanism

(75) Inventor: Tetsuhiro Kume, Tokyo (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 09/949,929

(22) Filed: Sep. 12, 2001

(30) Foreign Application Priority Data
Sep. 12, 2000 (JP) 2000-275886

(51) Int. Cl. H04M 1/00

(52) U.S. Cl. 455/566; 455/575

(57) ABSTRACT

A radio communication terminal includes a novel lighting control mechanism for selectively changing a lighting part in the radio communication terminal during a suitable time for a detected operating communication mode. The lighting part is flexibly changed in consideration of the detected operating communication mode to reduce total power consumption of the radio communication terminal. For example, if a moving picture communication mode is detected, the lighting control mechanism lights the display, but not the key operating unit, and if a voice call mode is detected, both the display and the key operating unit are not lighted. Further the lighting control mechanism can include a brightness control unit for controlling the brightness of the selected lighting suitable for a detected operating communication mode.

### CROSS REFERENCE TO RELATED APPLICATION

This application claims the benefit of Japanese Patent Application No. P2000-275886, filed on Sep. 12, 2000, the disclosure of which is expressly incorporated herein by reference in its entirety.

### BACKGROUND OF THE INVENTION

1. Field of the Invention

The invention relates to a radio communication terminal having different radio communication modes. More particularly, the invention relates to a lighting control mechanism for flexibly lighting a part of the radio communication terminal in accordance with an operating radio communication mode.

2. Description of the Related Art

Typically, a radio communication terminal, such as a mobile telephone, includes a display, such as a liquid crystal display (LCD), and a key operation unit having a plurality of keys. Further, the radio communication terminal includes a lighting control mechanism for back lighting the display and the plurality of keys in the key operating unit when the radio communication terminal transmits and receives radio data to and from a base station through an antenna.

Usually, a conventional lighting control mechanism performs lighting on and off operations for back lighting both the display and the key operating unit at the same time. Thus, if the radio communications terminal receives radio data from a base station though the antenna or detects data input through the key operating unit, the lighting control mechanism turns on the lighting for both the display and the key operating unit simultaneously.

In order to limit power consumption, the conventional lighting control mechanism limits the lighting on time for both the display and the key operating unit for a predetermined period of time. Since the lighting control mechanism controls both the display and the key operating unit simultaneously, even though the predetermined period of time has passed, the conventional lighting control mechanism may seriously inconvenience a user's operations by turning the lighting off.

In order to obviate such shortcomings, another lighting control mechanism, disclosed in Japanese Laid Open Patent 10-200615, has been proposed. This mechanism controls both the display and the key lighting operation with more suitable timing by varying the predetermined light-on time in accordance with a status of an operating program. Although the mechanism varies the lighting-on time depending on the program, it still inconveniences the user since both the display and the key operating unit are still simultaneously lighted on and off.

Therefore, there is a need in the art for a radio communication terminal control mechanism that reduces the power consumption of a radio communications terminal while more conveniently lighting both the display and the key operating unit.

### SUMMARY OF THE INVENTION

In accordance with the current invention, a customer relationship management architecture method and system are provided that avoid the problems associated with prior art radio communication terminal control mechanisms as discussed herein above.

In one aspect, a radio communication terminal having a plurality of communication modes comprising a transmitter-receiver unit configured to transmit and receive data, an input unit configured to input data, a display unit configured to display the data received by the transmitter-receiver unit and the data inputted by the input unit, a lighting unit configured to independently light the input unit and the display unit, a recognition unit configured to recognize an operating communication mode among the plurality of communication modes, and a control unit configured to control the lighting unit in accordance with the recognized operating communication mode.

In another aspect, a radio communication terminal having a plurality of communication modes for transmitting and receiving data comprising an input unit configured to input data, the input unit which includes a first key and a second key a lighting unit configured to independently light the first and second keys, a recognition unit configured to recognize an operating communication mode among the plurality of communication modes, and a control unit configured to control the lighting unit in accordance with the recognized operating communication mode.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and, together with the detailed description, explain the principles of the invention. In the drawings:

FIG. 1 is a block diagram illustrating components of a radio communication terminal applicable to an apparatus and method for controlling lighting operation according to an embodiment of the invention.

FIG. 2 is a block diagram illustrating components of the lighting control mechanism in the radio communication terminal shown in FIG. 1.

FIG. 3 illustrates an embodiment of a circuit diagram applicable to lighting control mechanism according to the invention.

FIG. 4 is a flowchart of an embodiment of the invention for performing lighting control consistent with the invention.

FIG. 5 illustrates another embodiment of a circuit diagram applicable to a lighting control mechanism according to the invention.

### DESCRIPTION OF THE PREFERRED EMBODIMENTS

Reference will now be made in detail to embodiments of the invention, examples of which are illustrated in the accompanying drawings. Wherever possible, the same reference numbers will be used throughout the drawings to refer to the same or like parts.

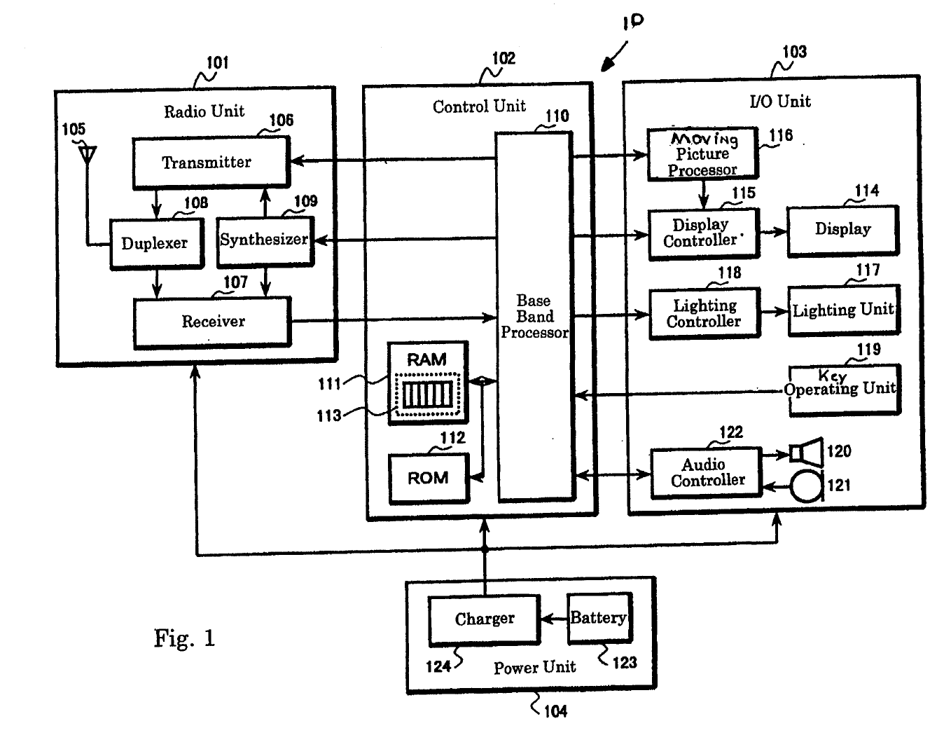

As illustrated in FIG. 1, a radio communication terminal 10 consistent with the invention comprises a radio unit 101, a control unit 102, an I/O unit 103, and a power supply unit 104. Radio unit 101 includes an antenna 105, a transmitter 106, a receiver 107, a duplexer 108 and a synthesizer 109. Control unit 102 includes a base band processor 110 for controlling operations in the radio communication terminal, a random access memory (RAM) 111 as a primary memory, and a read only memory (ROM) 112 for storing various control programs for the operations of radio communication terminal 10. RAM 111 includes a flag area 113.

I/O unit 103 includes a display 114, such as a liquid crystal display (LCD), a display controller 115, a moving picture processor 116, a lighting unit 117, a lighting controller 118, a key operating unit 119 including a plurality of keys, a speaker 120, a microphone 121 and an audio controller 122. Power supply unit 104 includes a battery 123 and a battery charger 124. Radio unit 101, control unit 102 and I/O unit 103 are supplied power from power supply unit 104.

Antenna 105 in radio unit 101 transmits and receives radio signals to and from a base station (not shown). The signals received through antenna 105 are transmitted to duplexer 108 and receiver 107 in radio unit 101 and are further transmitted to base band processor 110 in control unit 102. When radio communication terminal 10 transmits signals to the base station, base band processor 110 in control unit 102 sends the transmitting signals to transmitter 106 in radio unit 101. Transmitter 106 transmits the signals to duplexer 108 that transmits the data through the air through antenna 105. Further, base band processor 110 in control unit 102 controls synthesizer 109 in radio unit 101 so as to exchange communication channels for a transmission time and a reception time of radio communication terminal 10.

Flag area 113 in RAM 111 is used for indicating an operation status or non-operation status of a particular program. Thus, each of a plurality of flags stored in flag area 113 correspond to a particular operating communication mode of radio communication terminal 10, such as a voice call mode, a moving picture communication mode, a mailing mode, a browsing mode, or a visual telephone mode. Those skilled in the art will appreciate that many other operating communication modes may be stored in flag area 113. Thus, radio communication terminal 10 consistent with the invention can recognize the operating communication mode by storing a plurality of flags corresponded to each of the plurality of communication modes in RAM 111.

When a particular program is started under the control of base band processor 110, a flag corresponding to the particular program is set in flag area 113 by base band processor 110. When the operation of the particular program is complete, base band processor 110 cancels the flag corresponding to the particular program. Thus, radio communication terminal 10 consistent with the invention can store in memory a particular operating communication mode by setting and canceling a particular flag in flag area 113. Alternatively, a flag area functionally similar to flag area 113 may be placed in a RAM area within base band processor 110.

Display 114 displays data received through radio unit 101 or data and commands inputted through key operating unit 119 under the control of display controller 115. Moving picture processor 116 supplies moving picture data to display controller 115 by decoding received moving picture data. The received moving picture data may comprise moving picture experts group phase 4 (MPEG4), however, those skilled in the art will appreciate that many other formats may be used.

Lighting unit 117 includes a plurality of light emitters, such as light emitting diodes (LEDs). Some of the light emitters are used for back lighting display 114 and the remainder are used for lighting the keys in key operating unit 119 under control of lighting controller 118.

Audio controller 122 controls output signals sent to speaker 120 and input signals from microphone 121. In addition to speaker 120 and microphone 122, I/O unit 103 may include a camera (not shown) for inputting images, or a vibrator (not shown) or a sounder (not shown) for signaling reception indication.

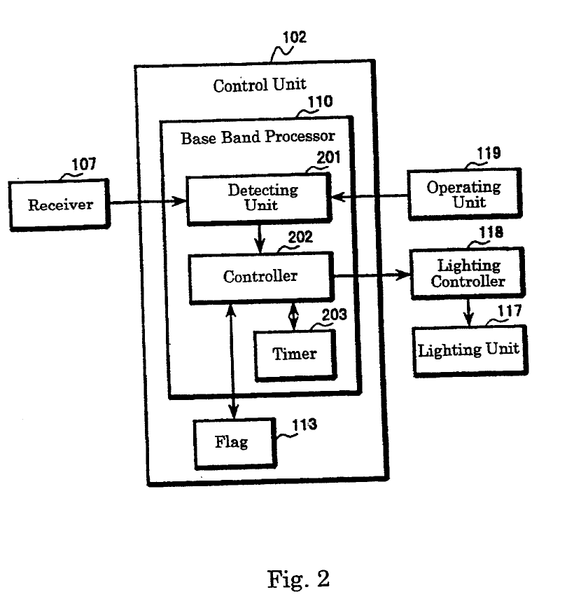

FIG. 2 illustrates components of a lighting control mechanism for radio communication terminal 10 consistent with the invention. As illustrated in FIG. 2, base band processor 110 includes a detecting unit 201, a controller 202, and a timer 203. Detecting unit 201 is coupled to receiver 107 in radio unit 101 and is configured for detecting reception of data from antenna 105. Further, detecting unit 201 is coupled to key operating unit 119 in I/O unit 103 for detecting input operation through the keys of key operating unit 119. The data detected by detecting unit 201 is transferred to controller 202. Controller 202 sends a control signal for setting timer 203 for controlling lighting controller 118. Thus, controller 202 sends lighting control data, which corresponds to the recognized operating communication mode, to lighting unit 117 by referencing flag area 113 for the operating communication mode. Alternatively, instead of setting a flag in RAM 111, a table for indicating the relationship between the recognized operating communication mode and the lighting control data may be stored in ROM 112.

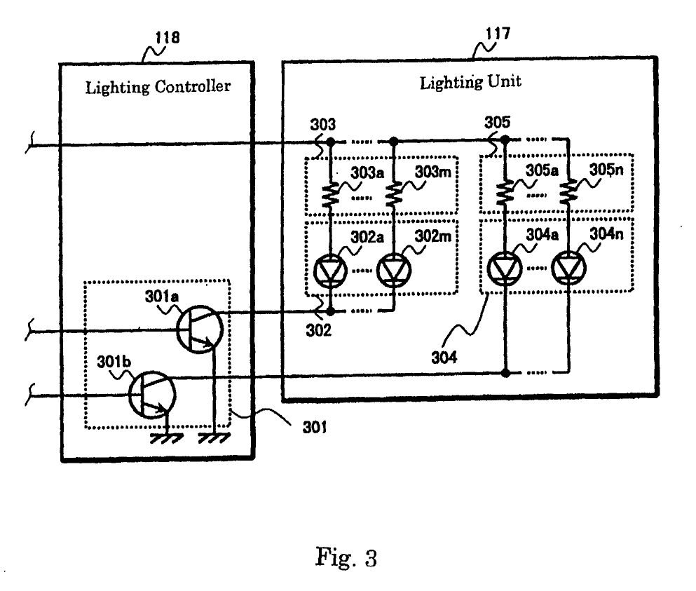

FIG. 3 illustrates circuits of the lighting control mechanism of radio communication terminal 10 consistent with the invention. Lighting controller 118 includes a first lighting control transistor 301a and a second lighting control transistor 301b for controlling lighting on/off operations of a first group of LEDs 302a-302m, and a second group of LEDs 304a-304n respectively in lighting unit 117. First group of LEDs 302a-302m are used for back lighting display 114. The second group of LEDs 304a-304n are used for lighting key operating unit 119. Second group of LEDs 304a-304n includes a plurality of LEDs that are coupled in parallel. Corresponding to each of the LEDs, a plurality of current controlling resistors are provided in lighting unit 117. A first group of current controlling resistors 303a-303m are disposed in parallel so as to correspond to each of the LEDs in first group of LEDs 302a-302m, and a second group of current controlling resistors 305a-305n are disposed in parallel so as to correspond to each of the LEDs in second group of LEDs 304a-304n. First lighting control transistor 301a and second lighting control transistor 301b control the flow of current to first group of LEDs 302a-302m, for lighting display 114, and to second group of LEDs 304a-304n, for lighting key operating unit 119, respectively. Whether lighting control transistors 301a and 301b turn on or shut off the flow of current is determined by control data supplied from controller 202 in control unit 102. Accordingly, light on and off for display 114 and key operating unit 119 are controlled.

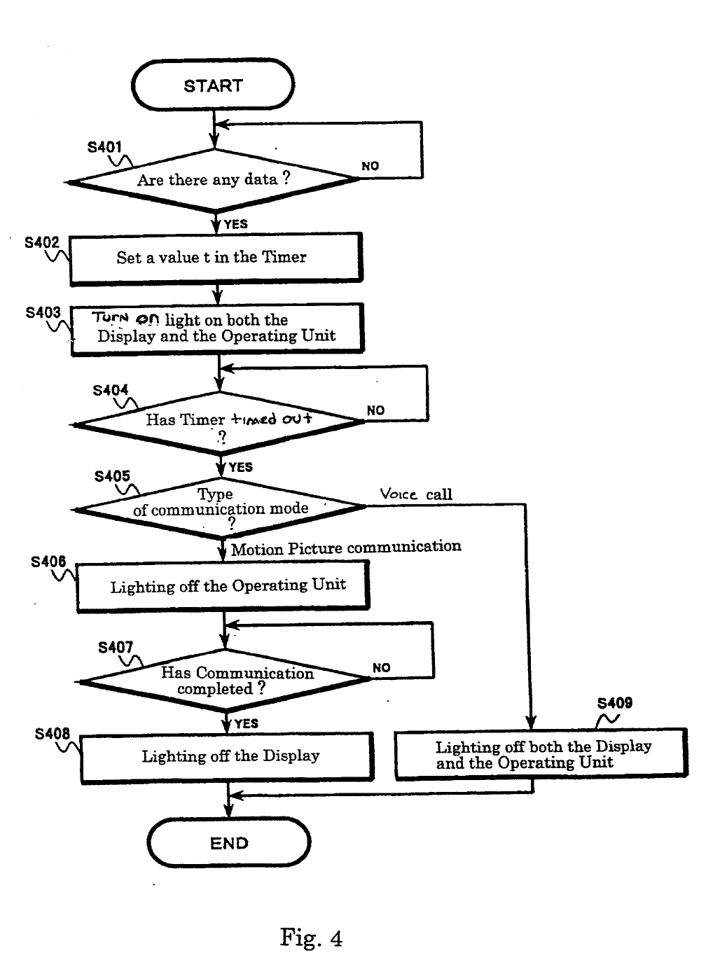

With reference to FIG. 4, an exemplary method for controlling the lighting for radio communication terminal 10 consistent with the invention is shown. In this exemplary method, radio communication terminal 10 operates under two different communication modes, for example, a voice call mode and a moving picture communication mode. Those skilled in the art will appreciate that radio communication terminal 10 may operate under more than two communication modes and under modes other than voice call or moving picture communication mode.

During operation of the radio communication terminal 10, detecting unit 201 in base band processor 110 detects whether reception data from receiver 107 or input data from key operating unit 119 is to be received (stage S401). When detecting unit 201 detects either of the aforementioned data, controller 202 sets timer 203 at a predetermined time t (stage S402). When controller 202 sets timer 203, controller 202 also turns on lighting control transistors 301a and 301b so as to turn on the lighting on both of first group of LEDs 302a-302m and second group of LEDs 304a-304n respectively. Thus the lighting is turned on for both display 114 and key operating unit 119 (stage S403). Controller 202 maintains the lighting for both display 114 and key operating unit 119 during the predetermined time t.

When timer 203 times out (stage S404), controller 202 determines the present communication mode by referencing flag area 113. Thus, in this example, whether the present communication mode is the moving picture communication mode or the voice call mode is determined in accordance with the status of flag area 113 (stage S405). If the present communication mode is determined to be the moving picture communication mode, controller 202 keeps the light-on state of lighting control transistor 301a for continuing the lighting for display 114. At the same time, controller 202 changes the state of lighting control transistor 301b to turn off second group of LEDs 304a-304n in order to save power because the lighting for key operating unit 119 is not necessary during the moving picture communication mode (stage S406). When the present communication has finished (stage S407), controller 202 turns off lighting control transistor 301a which turns off first group of LEDs 302a-302m for display 114 (stage S408).

At stage S405, however, if the present communication mode is determined to be the voice call mode, controller 202 turns off both lighting control transistors 301a and 301b for turning off both first group of LEDs 302a-302m and second group of LEDs 304a-304n. Thus the lighting for both display 114 and key operating unit 119 are off, since no lighting is required during the voice call mode (stage S409).

In this embodiment, at stage S405, it is determined whether the present communication mode is the voice call mode or the moving picture communication mode. These modes are examples of modes that light display 114 during a time when a user watches display 114. Examples of other similar modes include a mail mode, a browsing mode, or a TV communication mode.

Further it is possible to improve the operation of radio communication terminal 10 and conserve power by differing the lighting off time in accordance with a particular communication mode. For example, the time-out value of timer 203 in the voice call mode can be a smaller value than the time-out value of timer 203 in the mail communication mode.

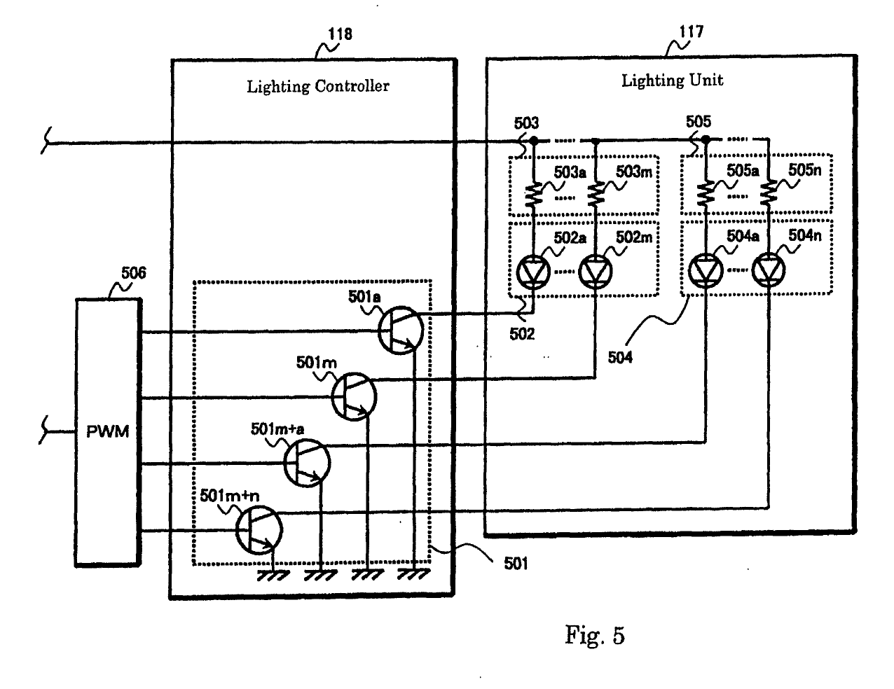

FIG. 5 illustrates another embodiment of the lighting control mechanism for a radio communication terminal consistent with the invention. In comparison to the embodiment shown in FIG. 3, lighting controller 118 includes an increased number of control lines through a plurality of lighting control transistors for controlling light on and off of a plurality of LEDs. Thus, lighting unit 117 includes a number m of LEDs 502a-502m for display 114 and a number n of LEDs 504a-504n for key operating unit 119. Consequently, lighting controller 118 includes a number m+n of lighting control transistors 501a, 501m, 501m+a, and 501m+n, respectively, for controlling lighting on and off states for each of the LEDs. Lighting unit 117 further includes a number m of current controlling resistors 503a-503m corresponding to each of LEDs 502a-502m for display 114 and a number n of current controlling resistors 505a-505n corresponding to each of LEDs 504a-504n for key operating unit 119. Thus, each of LEDs 502a-502m for display 114 is respectively coupled to each of current controlling resistors 503a-503m. And each of LEDs 504a-504n is respectively coupled to each of current controlling resistors 505a-505n. According to this embodiment, lighting can be controlled for a particular part, for example, a particular key in key operating unit 119 with accompanying lighting on display 114 in accordance with a communication mode.

For example, it becomes possible to light a call end key during the lighting on of display 114 during a moving picture communication mode. It is also possible to light a record key and a call end key during a voice call mode. Further, if a volume of receiving data is large and a scrolling display data is needed, it is possible to light a particular key for the scrolling. Thus, the usability of communication terminal 10 can be improved.

In FIG. 5, a pulse width modulator (PWM) 506 is provided between base band processor 102 and lighting control unit 118 for controlling brightness of the light emitting elements, such as LEDs, by pulse driving of them. Thus, PWM 506 generates a PWM signal based on control data from controller 202 in base band processor 102. The PWM signal is supplied to each of lighting control transistors 501a, 501m, 501m+a, and 501m+n in order to control the brightness of each of the number m+n of LEDs 502a-502m, and 504a-504n. It is possible to store the relationship between the brightness for a particular light emitting element and a communication mode in ROM 112.

In view of the foregoing, it will be appreciated that the present invention provides a system and method for providing a radio communication terminal having a lighting control mechanism. Still, it should be understood that the foregoing relates only to the exemplary embodiments of the present invention, and that numerous changes may be made thereto without departing from the spirit and scope of the invention as defined by the following claim.

What is claimed is:

1. A radio communication terminal having a plurality of communication modes, comprising:
a transmitter-receiver unit configured to transmit and receive data;
an input unit configured to input data;
a display unit configured to display the data received by the transmitter-receiver unit and the data inputted by the input unit;
a lighting unit configured to independently light the input unit and the display unit;
a recognition unit configured to recognize an operating communication mode among the plurality of communication modes; and
a control unit configured to control the lighting unit in accordance with the recognized operating communication mode.

2. The radio communication terminal according to claim 1, wherein:
the control unit controls brightness for the input unit and the display unit respectively in accordance with the recognized operating communication mode.

3. The radio communication terminal according to claim 1, wherein:
the lighting unit includes a first lighting system for lighting the input unit and a second lighting system for lighting the display unit; and
the control unit controls brightness of the respective first and second lighting systems in accordance with the recognized operating communication mode.

4. The radio communication terminal according to claim 3, wherein:
the input unit includes a first key and a second key;
the first lighting system independently lights up the first and second keys; and
the control unit controls the brightness of the first and second keys respectively in accordance with the recognized operating communication mode.

5. The radio communication terminal according to claim 2, wherein:
the plurality of communication modes includes a voice call and mode for transmitting and receiving voice data;
the recognition unit determines whether the operating communication mode is the voice call mode; and
the control unit makes the lighting unit light the input unit and the display unit when data is received by the transmitter-receiver unit or inputted by the input unit, and lowers or switches off the lights of the input unit and the display unit when the recognized operating communication mode is the voice call mode after a predetermined time of the lighting.

6. The radio communication terminal according to claim 5, wherein:
the control unit lowers or switches off the light of the input unit if the operating communication mode is other than the voice call mode after the predetermined time of the lighting.

7. A radio communication terminal having a plurality of communication modes for transmitting and receiving data, comprising:
an input unit configured to input data, the input unit which includes a first key and a second key.
a lighting unit configured to independently light the first and second keys;
a recognition unit configured to recognize an operating communication mode among the plurality of communication modes; and
a control unit configured to control the lighting unit in accordance with the recognized operating communication mode.

8. The radio communication terminal according to claim 7, wherein:
the control unit controls brightness of the respective first and second keys in accordance with the recognized operating communication mode.

9. The radio communication terminal according to claim 7, wherein:
the lighting unit includes a first lighting system for lighting the first key and a second lighting system for lighting the second key; and the control unit controls brightness of the respective first and second lighting systems in accordance with the recognized operating communication mode.
